(19) United States
(12) Patent Application Publication
(10) Pub. No.: US 2010/0042555 A1
(43) Pub. Date: Feb. 18, 2010

(54) EXERCISE FACILITY

(76) Inventors: Amir Ranen, Bnei Brak (IL); Mira Ranen, Bnei Brak (IL)

Correspondence Address: DEBORAH A. GADOR, P.O. BOX 4133, GANEL TIKVA, 55900, IL

(21) Appl. No.: 12/443,491

(22) PCT Filed: Sep. 24, 2007
(86) PCT No.: PCT/IL2007/001176

§ 371 Date: Mar. 30, 2009

(30) Foreign Application Priority Data
Sep. 28, 2006 (IL) 178371

(51) Int. Cl. G06Q 10/00; E04H 14/00

(52) U.S. Cl. 705/418; 52/27; 52/79.1

(57) ABSTRACT

The present invention relates to an exercise facility including a compact exercise booth for an individual to be erected in public areas, the exercise booth including an exterior wall, equipment for performing exercises coupled to the wall, means for collecting payment for use of the booth during a pre-set period of time, and a timer inside the booth for determining time a person is inside the booth. There is further provided according to the invention, a method for providing exercise services, the method including providing an exercise facility, the exercise facility including an exercise booth equipment for performing exercises coupled to the wall, and a timer inside the booth for determining time a person is inside the booth, erecting the exercise facility in the vicinity of a waiting area, and providing means for collecting payment for use of the booth during a pre-set period of time.

### FIELD OF THE INVENTION

The present invention relates to an exercise facility, in general and, in particular, to a personal exercise room.

### BACKGROUND OF THE INVENTION

Nowadays, there are many places where people must spend time waiting. These include train and bus stations, airports, hospitals, etc. In order to pass the time, people must bring with them reading matter, music players, games, etc., or merely sit and wait.

On the other hand, when people wish to exercise, they must go to a gym or spa, or other location organized and arranged specifically for exercising. Such places are arranged with all the necessary equipment, but are not located or arranged so as to be accessible to passers-by.

There is known from U.S. Pat. No. 5,577,981 a virtual reality exercise machine including a booth-like enclosure, exercise apparatus, and an image display helmet, preferably intended for installation in health clubs and gymnasiums. This is a complex device with complicated equipment, and requires access to a source of electricity.

There is also known, from U.S. Pat. No. 5,743,050, a compact training room also serving as a bed room. The training room includes a bed on which the exerciser sits or lies during training, and then can fall asleep immediately following the training, so as to maintain an increased level of growth hormone in the blood after heavy-load training while he is sleeping. This training room also includes exercise equipment for heavy-load training, and its purpose is to permit an exerciser to sleep immediately after finishing exercising.

Accordingly, there is a long felt need for an exercise facility suitable for erection in a selected location, to permit individual exercise during a waiting period by those in the vicinity of the exercise facility, and it would be desirable if such a device provided privacy to the user, as well as portability, for transport and erection in different waiting areas.

### SUMMARY OF THE INVENTION

There is provided according to the present invention an exercise facility including a compact exercise booth for an individual to be erected in public areas, the exercise booth including an exterior wall, equipment for performing exercises coupled to the wall, means for collecting payment for use of the booth during a pre-set period of time, and a timer inside the booth for determining time a person is inside the booth.

Preferably, the booth is also provided with a ventilation device—for example, a window, a fan, air conditioning, etc.

Preferably, the payment is paid in advance for a fixed period of time. A coin box, credit card swiper, cell phone, or any other payment collection means may be employed. Alternatively, the payment collection means may include a device for reading a smart card for exercisers having membership in an exercise club or regimen.

According to one embodiment of the invention, the timer includes a warning device, such as an alarm, to warn the exerciser that the end of the pre-paid time period is approaching or has passed.

According to another embodiment, the exercise facility includes a plurality of booths, each for an individual, coupled to one another or arranged in the same location.

If desired, the exercise booth may also include a data collection mechanism for collecting various variables of an exercise session—time spent, calories burnt, performance, vital signs, etc. These data can be collected on a memory device or sent to a user's computer over the Internet.

According to one embodiment of the invention, the exercise facility is portable, and can be easily disassembled and erected in another area where people are waiting and have time for exercising.

According to one embodiment of the invention, the booth includes equipment for anaerobic exercises, so that the exerciser need not perspire.

According to another embodiment, the exercise facility further includes a dressing room, which may include a shower. In this case, the booth may include equipment for aerobic exercise, in addition or instead of equipment for anaerobic exercise.

There is further provided according to the invention, a method for providing exercise services, the method including providing an exercise facility, the exercise facility including an exercise booth equipment for performing exercises coupled to the wall, and a timer inside the booth for determining time a person is inside the booth, erecting the exercise facility in the vicinity of a waiting area, and providing means for collecting payment for use of the booth during a pre-set period of time.

### BRIEF DESCRIPTION OF THE DRAWINGS

The present invention will be further understood and appreciated from the following detailed description taken in conjunction with the drawings in which:

FIG. 1 is a schematic illustration of an exercise facility constructed and operative in accordance with one embodiment of the present invention; and

FIG. 2 is a schematic illustration of an exercise facility constructed and operative in accordance with another embodiment of the present invention.

### DETAILED DESCRIPTION OF THE INVENTION

The present invention relates to an exercise facility adapted to be erected in waiting areas, which permits an individual, or a small number of individuals, to stop for a brief period of exercise, before continuing on their way, and/or can be used by those who must spend time in locations where exercise facilities are not available and they wish to pass the time by exercising, such as a train car, airplane, or train, plane or bus station waiting room. The exercise facility includes at least one compact exercise booth, which may be similar to conventional photograph booths, and which includes exercise equipment and payment collection means.

Preferably, the exercise booth is relatively small and portable, or easily erected and removed. Most preferably, the exercise performed in the booth would not be aerobic, so would not require changing clothes or cause the exerciser to perspire, although, alternatively, a small cubicle for changing/removing clothing, and possibly a small shower stall, could be added and aerobic exercise performed.

The booth preferably contains exercise machinery or equipment that does not require much space. Thus, such a booth would be of practical use in a city, where people are in a hurry and little exercise is available outside of a gym or health club, or in train stations and airports where it is desired to pass the time.

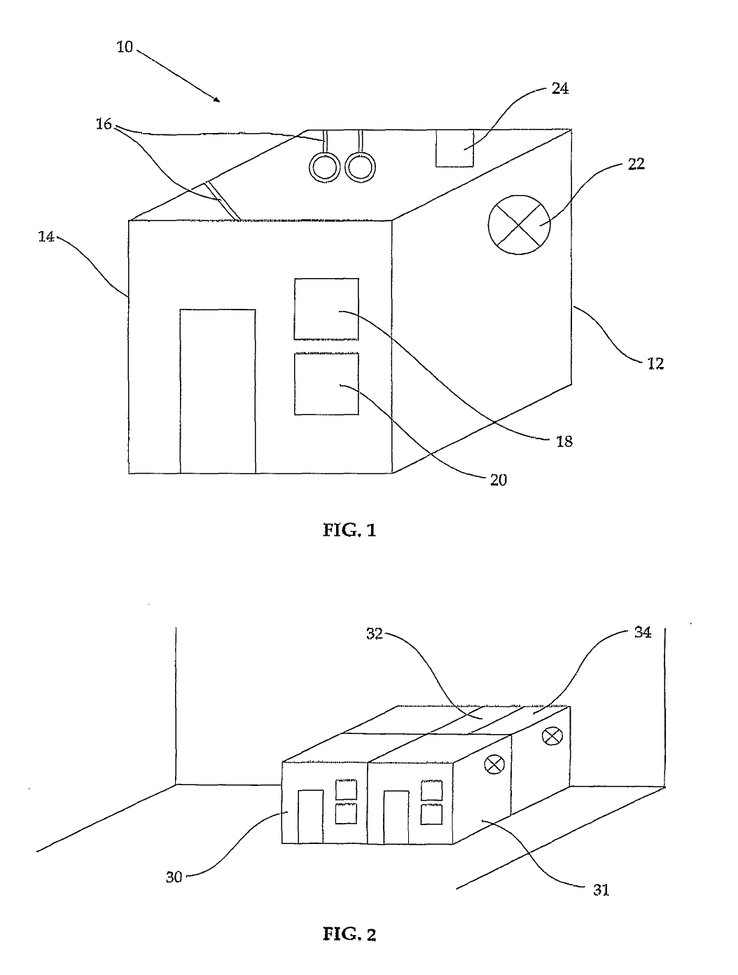

Referring now to FIG. 1, there is shown an exercise facility 10 constructed and operative in accordance with one embodiment of the present invention. Exercise facility 10 includes a compact exercise booth 12 having one or more external walls 14. Exercise booth 12 can have any desired shape, and can be free-standing or can be coupled to a wall or corner of a room. Exercise booth 12 includes exercise equipment 16 associated with the booth, preferably coupled to wall or walls 14. Preferably, exercise equipment 16 is adapted for performing anaerobic exercise. In this case, exercisers will not perspire, so there will be no need for changing clothes.

Means 20 for collecting payment is provided in the booth 12. The quantity of the payment is relative to the amount of time of use of the booth, or pre-defined units of time, which is measured by a timer 18 coupled to means 20 for collecting payment. Means 20 for collecting payment permits remote collection of “rental” payment for use of the booth during a pre-set period of time, which can be measured by timer 18. Payment of the rental fee can be made a condition of receiving access to the exercise equipment in the booth, or for entry into the booth in the first place. Preferably, the payment is collected in advance for a fixed period of time. A coin box, credit card reader, cell phone, or any other payment collection means may be employed. Alternatively, the payment collection means may include a device for reading a smart card for exercisers having membership in an exercise club or regimen which permits its members to use the facility.

According to one embodiment of the invention, timer 18 includes a warning device (not shown), such as an alarm, to warn the exerciser that the end of the pre-paid time period is approaching or has passed.

Preferably, the booth is also provided with a ventilation device 22, for example, a window, a fan, air conditioning, etc. Ventilation device 22 serves to provide circulation of air within the booth and in and out of the booth.

According to one embodiment of the invention, the exercise facility includes a plurality of individual booths 12, coupled to one another or divided by a partition, or arranged in the same location, as shown, for example, in FIG. 2.

If desired, the exercise booth may also include a data collection mechanism 24 for collecting data regarding various parameters of an exercise session, for example, time spent exercising, calories burnt, performance, vital signs, etc. These data can be collected on a memory device and/or sent to a user's computer over the Internet.

Preferably, the exercise facility is portable, and can be easily disassembled and erected in another area where people are waiting and have time for exercising.

According to an alternative embodiment of the invention, as in the exercise facility 30 shown in FIG. 2, the exercise booth 31 may include a changing room 32 for hanging or changing clothes. In addition, or instead, a small shower stall 34 can be provided, either self contained or couplable to a water pipe in the waiting room or other location where the exercise booth 31 is erected.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. An exercise facility comprising:
a compact exercise booth for an individual, adapted and configured to be erected in a public area, the exercise booth including:
an external wall,
equipment for performing exercises associated with the booth,
means for collecting payment for use of the booth during a pre-set period of time; and
a timer, coupled to the means for collecting payment, for measuring time of use of the booth.

2. The exercise facility according to claim 1, wherein said booth incorporates a ventilation device.

3. The exercise facility according to claim 1, further including means for permitting access to the booth on receipt of payment.

4. The exercise facility according to claim 1, wherein said timer includes a warning device, to warn an exerciser of the end of a pre-paid time period.

5. The exercise facility according to claim 1, comprising a plurality of booths, each for an individual, arranged in a single area.

6. The exercise facility according to claim 1, further comprising a data collection mechanism associated with the booth for collecting data of an exercise session in the booth.

7. The exercise facility according to claim 6, wherein said data is collected on a memory device or sent to a user's computer over the Internet.

8. The exercise facility according to claim 1, wherein the exercise facility is portable, and can be easily disassembled and erected.

9. The exercise facility according to claim 1, wherein said booth includes equipment for anaerobic exercises.

10. The exercise facility according to claim 1, wherein said booth includes equipment for aerobic exercises.

11. The exercise facility according to claim 1, wherein the exercise facility further includes a dressing room.

12. The exercise facility according to claim 1, wherein the exercise facility further includes a shower stall.

13. The exercise facility according to claim 1, wherein all said equipment for performing exercises is coupled to said wall.

14. A method for providing exercise services, the method comprising:
erecting an exercise facility by:
providing an exercise booth in a vicinity of a waiting area;
associating equipment for performing exercises with the booth; and
providing a timer inside the booth for measuring time of use of said booth; and
providing means for collecting payment for use of the booth during a pre-set period of time.

15. The method according to claim 14, wherein said step of associating includes coupling said equipment for performing exercises to a wall of said booth.

16. The method according to claim 14, further comprising associating a data collection mechanism with the booth for collecting data of an exercise session in the booth.

17. The method according to claim 14, further comprising incorporating a ventilation device in said booth.

18. The method according to claim 14, further comprising providing a dressing room in the facility.

19. The method according to claim 14, further comprising providing a shower stall in the facility.

20. The method according to claim 14, further including means for permitting access on receipt of payment.
